(19) United States
(12) Patent Application Publication
(10) Pub. No.: US 2019/0228384 A1
(43) Pub. Date: Jul. 25, 2019

(54) OPERATIONAL METRICS FOR ELECTRONIC DEVICES

(71) Applicant: Hewlett-Packard Development Company, L.P., Houston, TX (US)

(72) Inventors: Kevin WILLIAMS, San Diego, CA (US); Amit Kumar SINGH, Houston, TX (US); Gaurav ROY, Houston, TX (US)

(21) Appl. No.: 15/880,425

(22) Filed: Jan. 25, 2018

(51) Int. Cl. G06Q 10/00; G06Q 10/06

(52) U.S. Cl. CPC G06Q 10/20; G06Q 10/06393

(57) ABSTRACT

An example system includes memory to store a metric database table and a processor coupled to the memory. The metric database table includes a metric key and metric logic associated with the metric key. The metric logic is executable against a device datastore to extract metric data from the device datastore. The device datastore is to store operational data of a plurality of electronic devices. The processor is to query the metric database table to obtain the metric logic. The processor is to execute the metric logic against the device datastore to extract the metric data. The processor is to output extracted metric data in association with the metric key to an incident datastore to monitor for incidents related to operations of the plurality of electronic devices.

### BACKGROUND

Electronic devices are often managed by an organization, such as an organization deploying devices for its own use or for use by another organization. Devices may be deployed and then monitored for operational performance. Support staff may be employed to monitor and troubleshoot incidents that may result from device fault, software fault, or user error.

### BRIEF DESCRIPTION OF THE DRAWINGS

FIG. 1 is a block diagram of an example system including metric logic stored in a table to populate an incident datastore.

FIG. 2 is a flowchart of an example method of obtaining and outputting metric data.

FIG. 3 is a block diagram of another example system including metric logic stored in a table to populate an incident datastore.

FIG. 4 is a schematic diagram of example data structures of an example metric database table, an example incident database table, and example operational data.

FIG. 5 is a schematic diagram of an example method of obtaining and outputting metric data using the example data structures of FIG. 4.

FIG. 6 is a schematic diagram of example values for the example data structures of FIG. 4.

FIG. 7 is a schematic diagram of another example incident database table and example values.

FIG. 8 is a flowchart of another example method of obtaining and outputting metric data.

FIG. 9 is a flowchart of an example method of determining a time-based metric.

FIG. 10 is a block diagram of a Device-as-a-Service system including an example metric table and incident datastore.

### DETAILED DESCRIPTION

A system may identify and track incidents for a plurality of managed electronic devices using a portable structure. Examples of incidents include low free storage, hardware component failure, software crash, a state of settings, an old software version, a security incident, and similar. The portable structure may allow the system to be implemented consistently on a variety of platforms and database architectures. Further, the structure may accommodate a large volume of data that may be expected in many deployments, such as Device-as-a-Service (DaaS) ecosystems.

The portable structure may include a metric database table that stores metric logic, such as structured query language (SQL) queries, that may be executed against a datastore of device operational data or measurements, such as current available storage, for example. The results of execution of metric logic may be relevant to incidents. The portable structure may further include an incident datastore, which may include an incident database table that stores indications of incidents and information about such incidents.

The metric database table and incident datastore may be linked by a metric key. The incident datastore may store the metric key along with information to help support staff monitor and/or troubleshoot incidents. The metric database table may store the metric key in association with metric logic. Support staff can manage incidents as normal using the incident datastore and may reference the incident key to quickly understand the type of incident (e.g., low storage). The computationally intensive metric logic is kept separate and may be executed continually irrespective how the incident datastore is used. At the same time, the incident datastore may be regularly populated by the results of executed metric logic. Various different types of incidents may be stored in the same single incident database table.

When an organization has electronic devices that it will be managing, it is likely that an incident tracking system, as described herein, may be installed on the organization's preferred or preexisting platform and database architecture with little to no customization required. If the organization migrates to a new platform and/or database architecture, then the incident tracking system may be readily moved to the new platform and/or database architecture, again with little to no customization required. Further, if the incident tracking system is to be operated by cooperating organizations, it is likely that each organization already has or can readily obtain a suitable platform and/or database architecture. As such, the incident tracking system may be easier and faster to install.

In addition, an incident tracking system, as described herein, may provide a single storage location for its different functions. That is, all incidents may be stored in one table and all rules for deciding when incidents occur may be stored in another table. As such, an organization's support staff may find it easier to install, configure, and/or operate the incident tracking system, as the information for a particular task is all at the same location. Further, the storage locations of incidents and their underlying triggering rules may be linked in a consistent and reliable way, so that support staff may readily understand the cause of a particular incident.

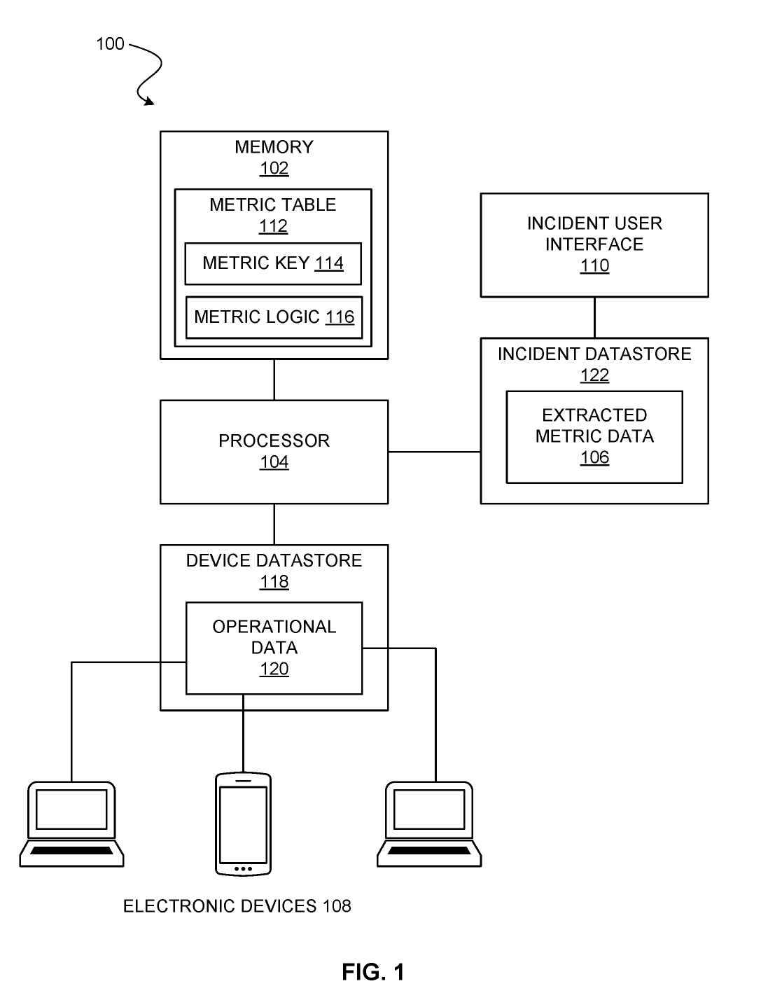

FIG. 1 shows an example system 100. The system 100 includes memory 102 and a processor 104 coupled to the memory 102. The system 100 may provide metric data 106 of a plurality of electronic devices 108 to an incident user interface 110. Incidents, such as hardware/software states, hardware/software failures, settings, security information, and similar relating to the electronic devices 108 may be managed by support staff via the incident user interface 110. Examples of electronic devices 108 include desktop computers, notebook computers, smartphones, tablet computers, and similar.

The processor 104 may include a central processing unit (CPU), a graphics processing unit (GPU), a microcontroller, a microprocessor, a processing core, a field-programmable gate array (FPGA), or similar device capable of executing instructions. The processor 104 may cooperate with the memory 102 to execute instructions. The memory 102 may include a non-transitory machine-readable storage medium that may be an electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, a storage drive, an optical disc, and the like. The machine-readable storage medium may be encoded with executable instructions.

The memory 102 is to store a metric database table 112. The metric database table 112 may be a table of a relational database. The metric database table 112 includes a metric key 114 and metric logic 116, which may be defined as columns of the table 112. The metric key 114 and the metric logic 116 may be associated by, for example, being contained in the same row of the table 112. The metric key 114 may be a primary key of the metric database table 112 and may be set to automatically increment as new metric logic 116 is inserted into the metric database table 112. The metric key 114 may be a natural number.

The metric logic 116 is executable against a device datastore 118 that stores operational data 120 of the plurality of electronic devices 108. The metric logic 116 is executable by the processor 104 to extract metric data 106 from the device datastore 118. The metric logic 116 may define both an element of operational data 120 and comparison for that element of operational data 120. For example, metric logic 116 for a “Low Storage” metric may define operational data 120 as all storage devices for an electronic device and may define a value of 20% for comparison. As such, electronic devices 108 measured to have less than 20% of storage capacity available may trigger an incident under the “Low Storage” metric.

Operational data 120 may include data that is directly or indirectly measured and/or data that is inferred from measurements. Examples of operational data 120 may include hardware health data, such as hardware state (e.g., remaining storage space, CPU usage, etc.), hardware error indicators, hardware settings, hardware versions, indications of the presence/absence of specific hardware, and similar. Examples of operational data 120 may include software health data, such as software error indicators, indications of software crashes, software settings, software version information, and similar. Examples of operational data 120 may include security compliance data, such as security settings, indications of security incidents, the presence/absence of security information (e.g., up-to-date encryption certificates), and similar.

Operational data 120 may be collected at the device datastore 118 by a query-response methodology. For example, the device datastore 118 may contain executable instructions that queries the electronic devices 108 for operational data 120. Operational data 120 may be transmitted by the electronic devices 108 without request from the device datastore 118. For example, an electronic device 108 may include executable instructions that periodically transmit operational data 120 to the device datastore 118. Various other methodologies of the device datastore 118 obtaining operational data 120 related to a plurality of electronic devices 108 may be used. Various different device datastores 118 with different sets and/or formats of operational data 120 may be used. For instance, a device datastore 118 may be used to manage portable electronic devices and hence may include current battery level as operational data 120, and a different device datastore 118 may be used to manage desktop computers and hence may omit current battery level as operational data 120. The device datastore 118 may include a relational database that may be queried via SQL.

The processor 104 is to query the metric database table 112 to obtain the metric logic 116, then execute the metric logic 116 against the device datastore 118 to extract the metric data 106 from the operational data 120. The processor 104 may continually cycle through each metric key 114 to obtain and execute the associated metric logic 116. The processor 104 is further to output the extracted metric data 106 in association with the metric key 114 to the incident datastore 122 to display the extracted metric data 106 at the incident user interface 110.

The metric logic 116 may include SQL expressions to query the device datastore 118. The metric logic 116 may include an expression to select specific data from the operational data 120 that meet a specific condition, so as to obtain extracted metric data 106 from the operational data 120 of the plurality of electronic devices 108. An example of such an extraction expression in SQL is:

SELECT deviceID WHERE RemainingStorageSpace<0.20

where deviceID is a unique identifier of each device that meets the condition of having less than 20% storage capacity remaining, as stored in a field named RemainingStorageSpace.

The metric logic 116 may include an expression to insert extracted metric data 106 into an incident datastore 122. The incident datastore 122 may include a relational database that may have data inserted via SQL. An example of such an insertion expression in SQL is:

INSERT INTO incidents (deviceID, metricID, timestamp) VALUES (D111′, 123, 2018-03-23 06:45:19)

where the fields named deviceID, metricID, and timestamp in a table called incidents are updated to include a row of respective values that may be obtained from execution of an extraction expression (e.g. deviceID), from the metric logic 116 (e.g., metricID), and/or from other processes (e.g., timestamp).

In the example above, the processor 104 queries the metric database table 112 to obtain an SQL query, such as a SELECT query, an INSERT INTO query, and/or similar, as the metric logic 116. The processor 104 then executes the metric logic 116 against the device datastore 118 to extract results of the query, such as a device identifier for a device that has low remaining storage capacity, as the metric data 106. The processor 104 then outputs the extracted metric data 106 in association with the metric key 114, such as a value of a primary key (e.g., 123), to the incident datastore 122 to display the extracted metric data 106 to support staff at the incident user interface 110. In this example, support staff may then be able to understand that an electronic device 108 with identifier “D111” has triggered an incident under a metric with an identifier “123” at 06:45:19 on 2018-03-23. The metric identifier “123” may be complemented by a human intelligible descriptor, such as “Low Storage”.

The incident user interface 110 may be provided to an electronic device having a display device and an input device. Such an electronic device may also contain the processor 104 and memory 102. In other examples, such an electronic device may be connected to the processor 104 and memory 102 via a computer network. The user interface 110 may include a graphical user interface (GUI) that may display text, images, icons, and/or similar GUI elements to allow a person to monitor for incidents that may occur in operations of the electronic devices 108. The same GUI elements may be reused among different metrics.

Incidents may be monitored by other systems or devices. That is, the incident datastore 122 may provide its data to another system or device that is to monitor for incidents that may occur in operations of the electronic devices 108. Such a system or device may raise an alarm or issue a notification in response to a given incident.

Metric logic 116 may be expressed in various languages, with SQL being an example. All metric logic 116 in a particular implementation of the system 100 may be expressed in the same language, so as to reduce resource requirements for the system 100, in that the system 100 need not implement several interpreters and/or compliers. Moreover, using only one standardized language for all metric logic 116 in a given implementation allows for the system 100 to be readily portable to various different platforms and architectures.

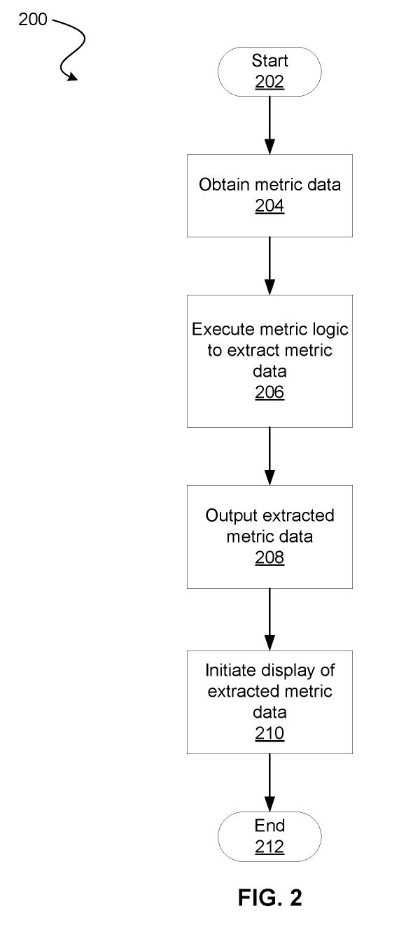

FIG. 2 shows an example method 200. The method 200 may be performed by the systems discussed herein. The method begins at block 202.

At block 204, a metric database table is queried to obtain metric logic. The metric database table may store metric logic as associated with a metric key and a metric descriptor. The metric logic may include an executable instruction, such as an SQL expression. The metric key may be a number or other index, which may be a primary key of the metric database table. The metric descriptor may be a human intelligible description of the metric logic.

At block 206, the obtained metric logic is executed against a device datastore that contains operational data of a plurality of electronic devices to extract metric data. This may include running a query, such as an SQL query, on a database that stores the operational data. The metric data may be representative of incidents related to the electronic devices, and such incidents may be related to hardware, software, and/or security.

Then, at block 208, the extracted metric data is outputted in association with the metric key to an incident datastore. This may include running a query, such as an SQL query, on a database of the incident datastore to insert the metric data into the incident datastore.

At block 210, the method initiates display of an indication of the extracted metric data. Display may be performed at incident user interface, such as a display device and GUI. Initiation of display may include transmitting, via a network for example, extracted metric data or an indication thereof to a device having a display device to cause the indication of the extracted metric data to be displayed. An indication may differ from the extracted metric data in that an indication may contain more or less information than the data itself, may be expressed in a different form (e.g., text instead of number, icon instead of value, etc.), or similar. The extracted metric data may be displayed in conjunction with a metric descriptor, such as a text string that describes the metric logic to support staff.

The method ends at block 212. The method may be repeated continually for various metrics that are monitored.

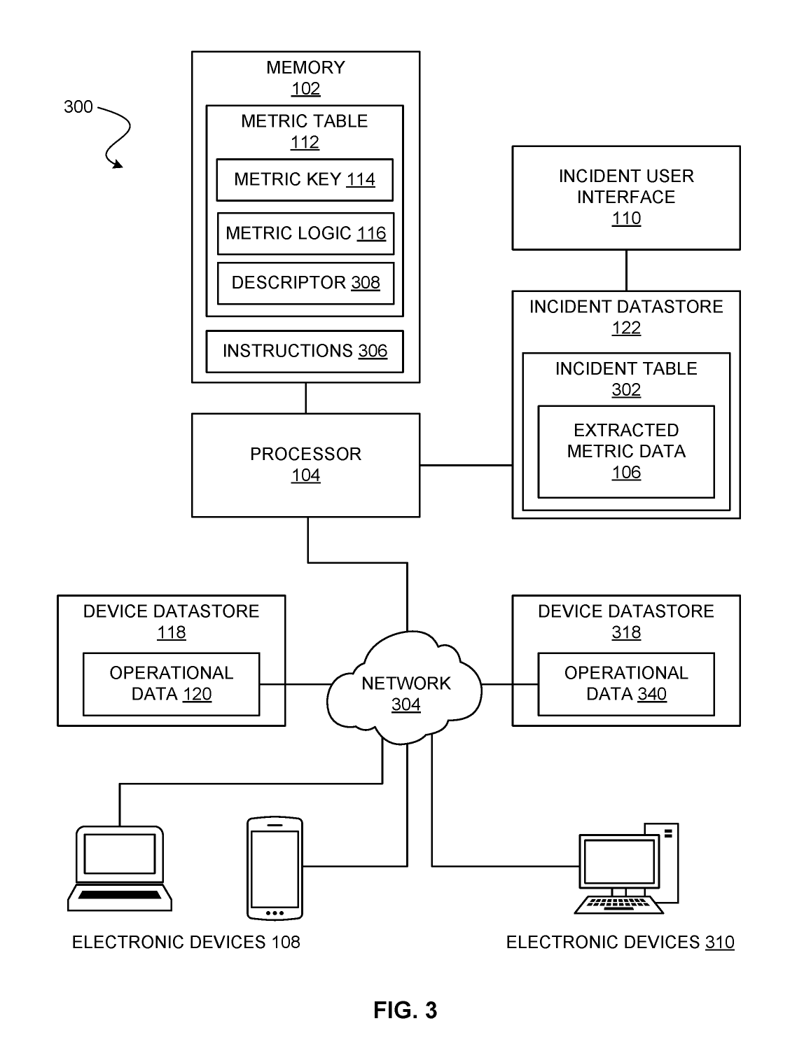

FIG. 3 shows another example system 300. The system 300 is similar to the other systems described herein and description of the other systems may be referenced. Like reference numerals denote like elements.

The system 300 may include a plurality of device datastores 118, 318, storing a plurality of sets of operational data 120, 340. Each datastore 118, 318 may serve a respective set of electronic devices 108, 310. The sets of electronic devices 108, 310 may be exclusive or may overlap. For example, the sets of electronic devices 108, 310 may be determined based on a device characteristic, such as portability and non-portability. One set of electronic devices 108 may include portable electronic devices, such as smartphones and notebook computers, and another set electronic devices 310 may include non-portable electronic devices, such as desktop computers and servers. The sets of electronic devices 108, 310 may be determined based on other criteria, such as device location, domain, owner, organization, and similar. The different sets of operational data 120, 340 may collect different data and may collect data in different formats.

The device datastores 118, 318 may be communicatively coupled to the electronic devices 108, 310 by a computer network 304. The computer network 304 may include a wide-area network, a local-area network, an intranet, a virtual private network (VPN), the internet, and/or similar.

An incident datastore 122 may store an incident database table 302, into which the processor 104 is to insert extracted metric data 106 related to the electronic devices 108, 310. The incident database table 302 may be a single table that stores metric data 106 extracted from the device datastores 118, 318 in a consistent format, regardless of the presence/absence of specific types of operational data 120, 340 and/or the format of available operational data 120, 340.

The processor 104 may be communicatively coupled to the device datastores 118, 318 by the computer network 304, as the device datastores 118, 318 may be implemented remote from the processor 104, for example, in a different organization or a different domain. For example, the device datastores 118, 318 may be maintained by different client organizations in a DaaS ecosystem that is managed by an organization that maintains the processor 104, memory 102, and incident datastore 122.

The processor 104 may be directly coupled to incident datastore 122, as the processor 104 and incident datastore 122 may be at the same server or domain. In other examples, a processor 104 is communicatively coupled to an incident datastore 122 by the computer network 304. In still other examples, a processor 104, memory 102, device datastore 108, 318, incident datastore 122, and incident user interface 110 are at the same server.

The memory may store a metric descriptor 308 in association with a metric key 114. The metric descriptor 308 may include a human intelligible description for metric logic 116 stored in association with the metric key 114.

The metric logic 116 may identify a device datastore 118, 318 for a particular metric. For example, a metric for battery health may be based on metric logic 116 that identifies a device datastore 118 associated with portable devices 108. More than one device datastore 118, 318 may be identified by metric logic. In other examples, all metric logic 116 may be executed for all device datastores 118, 318, and respective extracted metric data 106 may be provided to organizations that operate the devices 108, 303 corresponding to the device datastores 118, 318.

The system 300 may include instructions 306 stored in memory 102 and executable by a processor 104. The instructions 306 may query the metric database table 112 to obtain the metric logic 116, then execute the metric logic 116 against the device datastores 118, 318 identified by the metric logic 116 to extract the metric data 106. The instructions 306 may further output the extracted metric data 106 in association with the metric key 114 to the incident datastore 122 to display the extracted metric data 106 at the incident user interface 110. Further, the instructions may further output the metric descriptor 308 to the incident datastore 122 to display the metric descriptor 308 in association with the extracted metric data 106 at the incident user interface 110.

The instructions 306 may cause the processor 104 to continually cycle through each metric key 114 to obtain and execute the associated metric logic 116. Continually cycling through a plurality of metric keys 114 may be performed at a predetermined throughput or at a throughput governed by the execution time of the metric logic 116. Continually cycling through a plurality of metric keys 114 may be periodic, scheduled, or accord with another time-based methodology. In other examples, the instructions 306 may cause the processor 104 to continually execute metric logic 116 based on indications of priority. That is, a given element of metric logic 116 may be executed more or less frequently than another element of metric logic 116.

The instructions 306 may cause the processor 104 to apply a timestamp to extracted metric data 106 when inserting the extracted metric data 106 into the incident database table 302. The timestamp may originate from the underlying operational data 120, 340 or may be determined by the processor 104 when storing the extracted metric data 106. In any event, a time-series of extracted metric data may be accumulated at the incident datastore 122. That is, historic metric data may be accumulated, with metric data extracted at different times, but that may otherwise be identical, being distinguishable by respective timestamps. That is, the same device 108, 310 may trigger an incident under the same metric logic 116 for the same reason at different times. Timestamping of the extracted metric data 106 allows such data to be distinguished and further may provide a time-based understanding of the operation of a device.

The instructions 306 may further compare instances of extracted metric data at different times, that is, having different timestamps, to obtain a time-based metric. The instructions 306 may further initiate display of such a metric at the incident user interface 110. Such a metric may be related to a rate of change. For instance, a CPU usage spike may be detectable by comparing a previous measure of CPU usage with a current measure of CPU usage, both measures being obtained by the same metric logic 116 but having different timestamps.

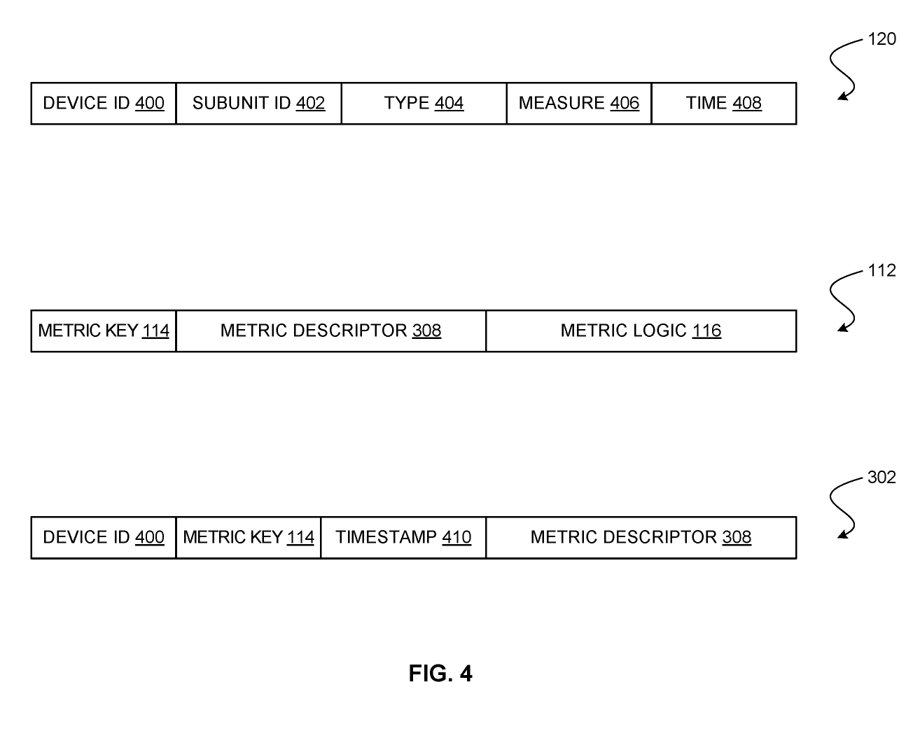

FIG. 4 shows example data structures for an example metric database table 112, example incident database table 302, and example operational data 120. Description elsewhere herein may be referenced for elements not described in detail here, with like reference numerals denote like elements.

The metric database table 112 may include fields for a metric key 114, a metric descriptor 308, and metric logic 116. Such fields may define columns of a table in a relational database. A given row of the metric database table 112 may define a given metric.

The operational data 120 may include fields for device identifier 400, subunit identifier 402, subunit type 404, measurement value 406, and time of measurement 408. Such fields may define columns of a table in a relational database. A particular row of operational data 120 may record a particular measurement.

The device identifier 400 may uniquely identify an electronic device. Examples of device identifiers 400 include serial number, Media Access Control (MAC) address, hardware/software signature, cryptographic key, hash, and similar.

The subunit identifier 402 may uniquely identify a component of the device, such as a hardware component, software component, security component, or similar. Examples of subunit identifiers 402 include a hardware address, a hardware enumeration, a hardware serial number, a MAC address, a hardware identifier, a software installation hash, a registry key/value, a cryptographic certificate, and the like.

The subunit type 404 may uniquely identify a type of a subunit. Various classes of subunit may have various types. For example, subunit identifiers 402 “STORE1” and “STORE3” listed for the same device identifier 400 may uniquely identify two mass storage devices with subunit types 404 of “HDD” for hard disk drive and “USB” for Universal Serial Bus mass storage device, respectively.

Subunit identifiers 402 may be grouped by class identifier, not shown, which may group common subunits, such as storage devices, power supplies, application software, and the like. Classes may also be distinguished by storing a set of operational data 120 for each class. That is, a table may be provided for storage devices, another table may be provided for power supplies, and so on.

Metrics may reference subunit type 404 and/or subunit class. For example, a metric may be constructed for remaining hard disk space, and such metric would specify subunit types 404 of “HDD” in this example. Another metric may be constructed for total remaining storage space, and such metric would specify the storage device class, as defined by a specific set of operational data 120 or by a specific class identifier in a larger set of operational data 120.

Measurement values 406 may store values of actual measurements taken for the respective subunit and may have various data types, depending on the measurement performed. Examples of measurements (and type) include remaining storage space (GB), CPU usage (percent), certificate expiry date (datetime), battery level (percent), software version (number), and similar.

Time of measurement 408 stores a time and/or date that the respective measurement values 406 was acquired. Time of measurement 408 may be timestamp.

The incident database table 302 may include fields for a device identifier 400, a metric key 114, a timestamp 410, and a metric descriptor 308. Such fields may define columns of a table in a relational database. A particular row of the incident database table 302 may indicate a particular incident.

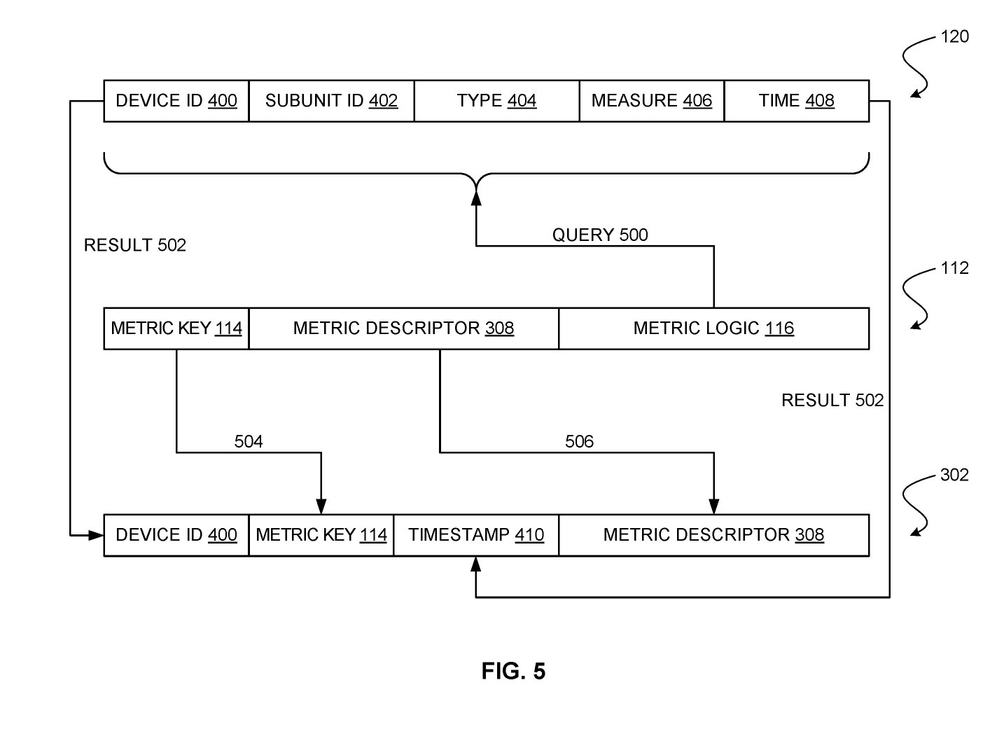

FIG. 5 schematically illustrates an example method of obtaining and outputting metric data using the example data structures of FIG. 4. Metric logic 116 may be used to query 500 the operational data 120 and return elements of operational data 120 relevant to understanding an incident as a result 502. Such a query may be constructed to return device identifiers 400 for devices that have measurement values 406 that meet a condition expressed in the metric logic 116. In another example, such a query may be constructed to return all device identifiers 400 in the operational data 120 with an indication of whether a condition expressed in the metric logic 116 was met or not. Moreover, a query may take the measurement time 408 from the operational data 120 as the timestamp 410 for the incident.

A metric key 114 and metric descriptor 308 may each be provided 504, 506 to the incident database table 302, separately or together, as part of the result 502 of the query 500 or as a separate query or process. For example, metric key 114 may be provided 504 as part of the query result 502 and metric descriptor 308 may be looked up 506 at the metric database table 112 using the metric key 114.

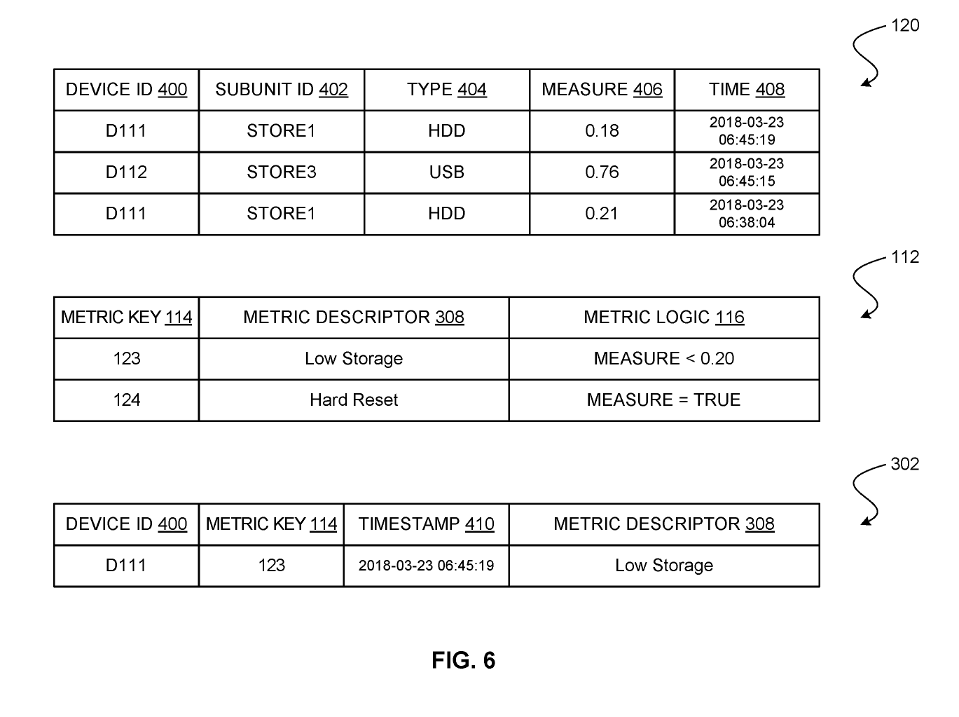

FIG. 6 shows example data for the data structures shown in FIG. 4. As can be seen, various different devices and subunits thereof have measurement values 406 stored as operational data 120. Various different metrics represented by the data contained in a metric database table 112 may be executed on the operational data 120 to obtain incident data that may be inserted into an incident database table 302. Incident data may be pulled from the operational data 120 and the metric database table 112.

In the example data shown, a “Low Storage” metric with metric key “123” is defined as a measurement of less than 0.20 or 20% of capacity remaining. Electronic device with identifier “D111” failed to trigger an incident under the “Low Storage” metric at 6:38 AM on March 23. However, electronic device “D111” did later trigger an incident under the “Low Storage” metric at 6:45 AM, as represented by data inserted into the incident database table 302 indicating same.

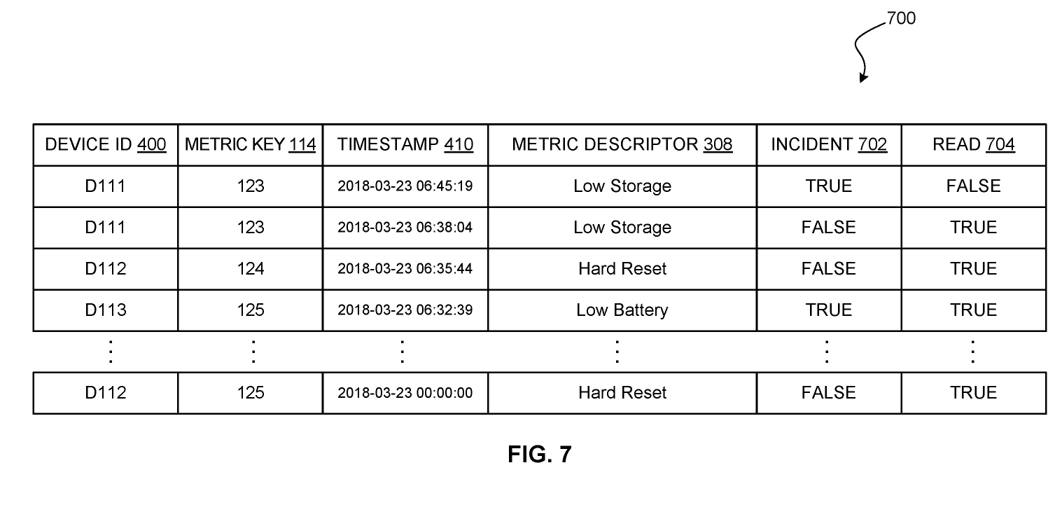

FIG. 7 shows another example incident database table 700. Description elsewhere herein may be referenced for elements not described in detail here, with like reference numerals denote like elements.

The incident database table 700 includes an incident field 702 in addition to fields 400, 114, 410, 308 described above. Such fields may define columns of a table in a relational database. A particular row of the incident database table 700 may indicate a particular incident.

Rows may be inserted into the incident database table 700 for elements of operational data 120 compared to metrics defined in a metric database table 112, irrespective of whether a condition in a metric is met. The incident field 702 may be set for each row based on whether a condition of the respective metric was met for the respective device. The incident field 702 may be set to a Boolean value of TRUE when the condition is met and may be otherwise set to FALSE. Hence, each row of the incident database table 700 may represent a check of one metric against one device, with incidents that may require further review flagged as TRUE in the incident field 702.

The incident database table 700 may further include a read field 704 that may be set to a Boolean value of FALSE initially and then set to TRUE after support staff has acknowledged review of the respective row. The read field 704 may facilitate filtering and/or sorting of the incident database table 700.

Storage of historic evaluations of metrics for various devices, whether incident conditions are met or not, may provide further useable information. Time-based metrics may be defined. For example, an increased CPU usage held over a threshold amount of time may indicate an incident that warrants attention.

The incident database table 700 is a single database table that may efficiently store a wide spectrum of different types of incidents. The particular logic behind each incident is available through the metric key 114 and need not be stored in the table 700 itself. The configuration of a particular device are available through the device identifier 400 and need not be stored in the table 700 itself. Further, a human-intelligible metric descriptor 308 may be stored in the table 700 or obtained when needed using the metric key 114, so that the metric descriptor 308 may be displayed to human support staff.

The data structures show in FIGS. 4-7 may allow for ready portability to a variety of different platforms and architectures. A given platform or architecture need only support the type of table described, as each of the operational data sets, metric tables, and incident tables accord to the same type of table. Moreover, this type of table is readily created and populated by SQL expressions.

Representations based on FIGS. 6 and 7 may be displayed at an incident user interface 110 to allow interaction with incident data by support staff. With reference to FIG. 7, for instance, the metric key 114 may be hidden, the incident and read fields 702, 704 may be provided with GUI elements, such as checkboxes, and information shown at device identifiers 400 and metric descriptor 308 may be linked to views of underlying data, such as device configuration and metric logic, respectively.

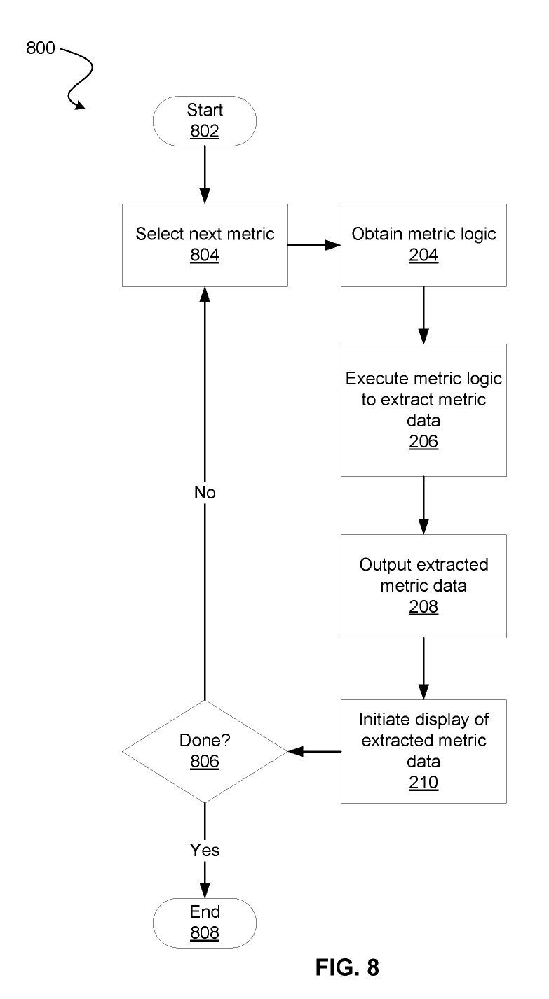

FIG. 8 shows an example method 800. The method 800 may be performed by any of the systems discussed herein. The method 800 is similar to the other methods described herein and description of the other methods may be referenced. Like reference numerals denote like elements. The method begins at block 802.

At block 804, a next metric is selected for evaluation. Metric selection may be based on a continually cycling through a plurality of metric keys to obtain respective metric logic. When the metric key is a natural number, metric keys may be cycled through by incrementation and resetting to the lowest metric key upon exceeding the highest metric key. Prioritized cycling may be used. For example, low priority metrics may be skipped a certain number of cycles.

Next, at blocks 204-210, metric data for the current metric is obtained and displayed as described elsewhere herein.

Then, at block 806, a termination condition may be evaluated to end the method 800 at block 808. A termination condition may be defined based on the particular cyclic methodology implemented. For example, the method 800 may be executed periodically for all metrics, wherein the termination condition defines the period. When the method 800 is not to be terminated, the method returns to block 804 to select the next metric to evaluate.

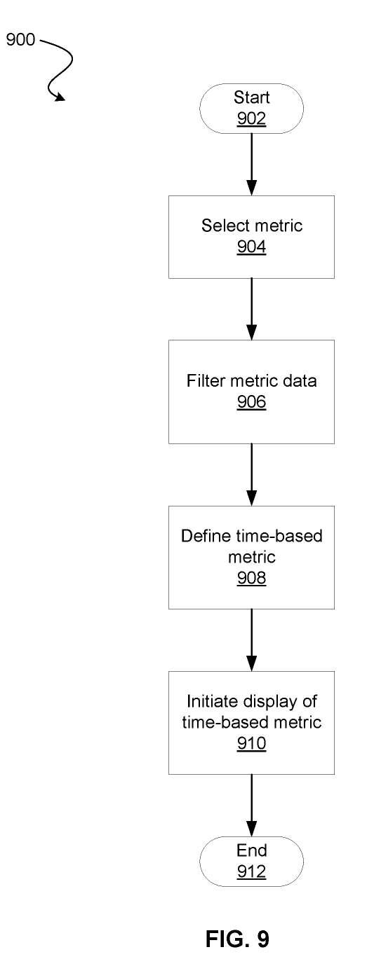

FIG. 9 shows an example method 900. The method 900 may be performed by any of the systems discussed herein. The method begins at block 902.

At block 904, a metric is selected. A metric may be selected by selecting a metric key or a group of related metric keys. For example, with reference to FIG. 7, the “Low Storage” metric may be selected.

At block 906, data related to the selected metric is filtered. Filtering may be performed to limit the metric to a particular device or group of devices, for example.

At block 908, a time-based metric is defined. For example, “Low Storage” over time may be defined as a time-based metric. This may include mapping metric data to a time scale to obtain the time-based metric. For example, low storage incidents may be grouped by day, and a series of consecutive days having 0, 0, 0, 1, 3, and 5 low storage incidents may indicate a future critical low storage incident.

At block 910, display of the time-based metric at an incident user interface is initiated and the method ends at block 912.

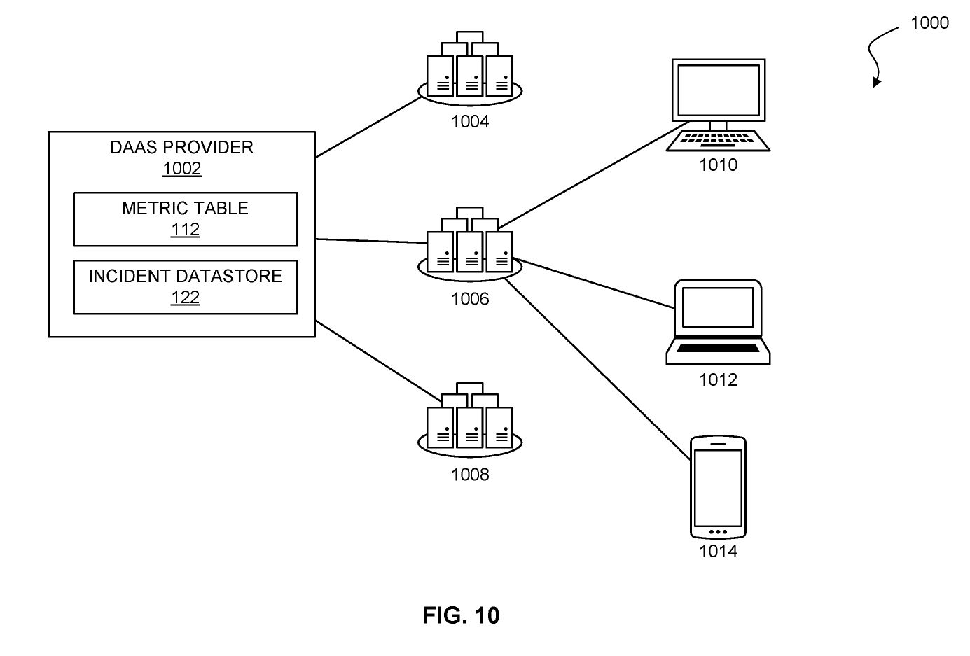

The systems and methods described herein may be implemented in a DaaS ecosystem, as shown in FIG. 10. In a DaaS ecosystem a DaaS provider provides the use of devices, such as electronic devices, to customers. The DaaS provider may retain responsibility for the devices, for example to maintain and/or maintain the devices.

The DaaS provider may collect data from the devices and/or customers within the DaaS ecosystem to assist with maintaining the devices and their performance. This data may be in the form of time-series data to allow for monitoring the performance of the devices and updating the status of the customers over time. Volume of such data may become large as there may be large numbers of customers and large numbers of devices per customer, subject to data collection over long periods of time.

The methods described herein may be applied in the context of a DaaS ecosystem to reduce the computational resources used to process and/or store the large volumes of data related to customers, the devices corresponding to each customer, and the metric data corresponding to each device. An example DaaS ecosystem may include a DaaS provider system 1002, which serves customer systems 1004, 1006, 1008, such as individuals and/or organizations.

The DaaS provider system 1002 may provide to each customer a number of managed electronic devices 1010, 1012, 1014. While electronic devices are shown in FIG. 10 only for customer system 1006, the other customer systems may also be provided with electronic devices. Moreover, while electronic devices 1010, 1012, 1014 are shown as connected to DaaS provider system 1002 through a customer system, it is contemplated that electronic devices 1010, 1012, 1014 may be in direct communication with DaaS provider system 1002.

Each electronic device 1010, 1012, 1014 may have measurements taken and stored for evaluation of metrics by the DaaS provider system 1002. As such, the DaaS provider system 1002 may implement a metric database table 112 and incident datastore 122, as described herein. The DaaS provider system 1002 may further implement a device datastore and/or incident user interface, as described herein.

In view of the above, it should be apparent that a large number of managed devices may be monitored for incidents with computational and storage efficiency. Using a table to store metric logic may reduce storage needs and may allow for various different metrics to be located in the same data structure. This may also provide for a simplified way to continually execute different metrics. Using a table to store extracted metric data, or data related to potential incidents, may reduce storage needs as references to devices and metric logic may be provided by respective identifiers stored in the table. Further, data of a wide range of different metrics may be stored in the same data structure without loss of understanding of such metrics. Moreover, the techniques described herein may be readily portable to a variety of platforms and architectures that need only support relational database tables and a language such as SQL.

It should be recognized that features and aspects of the various examples provided above can be combined into further examples that also fall within the scope of the present disclosure. In addition, the figures are not to scale and may have size and shape exaggerated for illustrative purposes.

1. A system comprising:
memory to store a metric database table, the metric database table including a metric key and metric logic associated with the metric key, the metric logic executable against a device datastore to extract metric data from the device datastore, the device datastore to store operational data of a plurality of electronic devices; and
a processor coupled to the memory, the processor to query the metric database table to obtain the metric logic, the processor to execute the metric logic against the device datastore to extract the metric data, the processor to output extracted metric data in association with the metric key to an incident datastore to monitor for incidents related to operations of the plurality of electronic devices.

2. The system of claim 1, wherein the processor is to continually query the metric database table to obtain the metric logic, execute the metric logic against the device datastore to extract the metric data, and output extracted metric data in association with the metric key to the incident datastore.

3. The system of claim 2, wherein extracted metric data is accumulated at the incident datastore, wherein the processor is to timestamp extracted metric data, wherein metric data extracted at different times are distinguishable by respective timestamps.

4. The system of claim 1, wherein the metric logic comprises structured query language.

5. The system of claim 1, wherein the incident datastore comprises an incident database table, wherein the processor is to insert the extracted metric data into the incident database table.

6. The system of claim 5, wherein the incident datastore comprises only a single incident database table.

7. The system of claim 1, wherein the metric database table further comprises a metric descriptor, the processor further to output the metric descriptor to the incident datastore to display the metric descriptor in association with the extracted metric data at an incident user interface.

8. The system of claim 1, further comprising the plurality of electronic devices as managed electronic devices in a Device-as-a-Service system.

9. A method comprising:
querying a metric database table to obtain metric logic, the metric database table storing the metric logic in association with a metric key and a metric descriptor;
executing the metric logic against a device datastore that contains operational data of a plurality of electronic devices to extract metric data;
outputting extracted metric data in association with the metric key to an incident datastore; and
initiating display of an indication of the extracted metric data in conjunction with the metric descriptor at an incident user interface.

10. The method of claim 9, further comprising continually cycling through a plurality of metric keys to obtain respective metric logic, execute the respective metric logic against a device datastore to extract respective metric data, and output the respective extracted metric data to the incident datastore.

11. The method of claim 9, further comprising timestamping the extracted metric data and accumulating timestamped extracted metric data at the incident datastore.

12. The method of claim 11, further comprising mapping extracted metric data to a time scale to obtain a metric and initiating display of the metric at the incident user interface.

13. The method of claim 11, wherein outputting the extracted metric data to an incident datastore comprises inserting the extracted metric data to a single database table.

14. The method of claim 11, wherein executing the metric logic against the device datastore comprises executing a structured query language query against a database table containing the operational data.

15. A system comprising:
an incident datastore; and
a processor to execute metric logic against a device datastore to store operational data of a plurality of electronic devices, the metric logic to extract metric data from the device datastore, the processor to output extracted metric data to the incident datastore;
the incident datastore containing an incident database table to store the extracted metric data and to monitor for incidents related to operations of the plurality of electronic devices.

16. The system of claim 15, wherein the metric logic includes an expression to query the device datastore and to insert the extracted metric data into the incident database table.

17. The system of claim 15, wherein the metric logic is to extract metric data from the device datastore irrespective of a condition expressed in the metric logic.

18. The system of claim 15, wherein the metric logic is to extract metric data only for operational data that meets a condition expressed in the metric logic.

19. The system of claim 15, wherein the operation data includes data from a measurement taken at the plurality of electronic devices, and wherein the metric logic defines a metric based on a comparison of a measurement to a condition.

20. The system of claim 15, wherein the metric logic is to accumulate metric data at the incident datastore over time, and wherein the processor is further to define a time-based metric from accumulated metric data.
